(19) United States
(12) Patent Application Publication
(10) Pub. No.: US 2025/0117461 A1
(43) Pub. Date: Apr. 10, 2025

(54) SYSTEMS AND METHODS FOR SECURING CONTENT AND RESOURCES

(71) Applicant: Capital One Services, LLC, McLean, VA (US)

(72) Inventors: Matthew HUNSBERGER, Hoboken, NJ (US); Tyler MAIMAN, Melville, NY (US); Joshua EDWARDS, Philadelphia, PA (US); Ian KATZMAN, Herndon, VA (US); Shahalam BAIG, Rochester, NY (US); Jackson WESTWOOD, New York, NY (US); Shasanka BHANDARI, McLean, VA (US)

(73) Assignee: Capital One Services, LLC, McLean, VA (US)

(21) Appl. No.: 18/905,172

(22) Filed: Oct. 3, 2024

Related U.S. Application Data
(60) Provisional application No. 63/587,891, filed on Oct. 4, 2023.
(60) Provisional application No. 63/665,485, filed on Jun. 28, 2024.
(60) Provisional application No. 63/683,063, filed on Aug. 14, 2024.

(51) Int. Cl. G06F 21/12; G06F 21/60

(52) U.S. Cl. CPC G06F 21/12; G06F 21/602

(57) ABSTRACT

A method may include receiving, using a browser module of a computing device, a decrypted video from a content decryption module, wherein the decrypted video is associated with a content element and a digital rights management technology. The method may include forming, using the browser module of the computing device, a HyperText Markup Language (HTML) element including the decrypted video. The method may include outputting, using an operating system of the computing device, the decrypted video of the HTML element to a display screen associated with the computing device. The method may include determining, using the operating system of the computing device, whether the outputted video is being played on the display screen. The method may also include transmitting, using the operating system of the computing device, the determination to the content decryption module.

### CROSS-REFERENCE TO RELATED APPLICATION(S)

This application claims the benefit of pending U.S. Provisional Patent Application No. 63/587,891, filed on Oct. 4, 2023, pending U.S. Provisional Patent Application No. 63/665,485, filed on Jun. 28, 2024, and pending U.S. Provisional Patent Application No. 63/683,063, filed on Aug. 14, 2024, each of which is incorporated herein by reference in its entirety.

### TECHNICAL FIELD

Various embodiments of this disclosure relate generally to techniques for securing content, and more particularly to systems and methods for securing content of a portal (e.g., a webpage, a website, an application, etc.) and resources associated with the portal.

### BACKGROUND

Organizations such as banks and healthcare providers seek to protect sensitive information (e.g., confidential information, personally identifiable information, financial information, medical information, etc.) from social engineers. A social engineer is a person or entity who seeks to manipulate a target (e.g., a customer or employee of an organization) into divulging sensitive information that may be used for fraudulent purposes. That is, a social engineer is a person or entity who engages in social engineering. For example, when the target is a user who uses a display screen (also referred to herein as a “screen”) of a computing device to view an account number on a bank's website, a social engineer using another computing device may persuade the user to reveal the account number to the social engineer. More specifically, the social engineer may convince the user to share the user's screen displaying the account number with the social engineer, using a screensharing or remote desktop application. In addition or in the alternative, the social engineer may convince the user to take a screenshot of the user's screen displaying the account number, using a screenshotting application, and then transmit the screenshot to the social engineer.

To guard against such social engineering, the bank may employ digital rights management (“DRM”) technologies, which are technologies that limit the use of digital content. For example, the bank may cause the user's display screen to present a video that is protected using DRM technologies. However, the bank may not know when the video is playing or not playing on the website.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods for securing content of a portal (e.g., a webpage, a website, an application, etc.) and resources associated with the portal, are disclosed. Each of the examples disclosed herein may include one or more features described in connection with any of the other disclosed examples.

In one aspect, an exemplary embodiment of a method may include receiving, using a browser module of computing device, a decrypted video from a content decryption module, wherein the decrypted video is associated with a content element and a digital rights management technology. The method may include forming, using the browser module of the computing device, a HyperText Markup Language (HTML) element including the decrypted video. The method may include outputting, using an operating system of the computing device, the decrypted video of the HTML element to a display screen associated with the computing device. The method may include determining, using the operating system of the computing device, whether the outputted video is being played on the display screen. The method may also include transmitting, using the operating system of the computing device, the determination to the content decryption module.

In a further aspect, an exemplary embodiment of a system may include at least one processor and at least one memory having programming instructions stored thereon, which, when executed by the at least one processor, cause the system to perform operations. The operations may include receiving, using a computing device, a decrypted video from a content decryption module, wherein the decrypted video is associated with a content element and a digital rights management technology. The operations may include forming, using a browser module of a computing device, a HyperText Markup Language (HTML) element including the decrypted video. The operations may include outputting, using an operating system of the computing device, the decrypted video of the HTML element to a display screen associated with the computing device. The operations may include determining, using the computing device, whether the outputted video is being played on the display screen. The operations may further include transmitting, using the operating system of the computing device, the determination to the content decryption module.

In another aspect, an exemplary embodiment of a method may include receiving, using a computing device, a decrypted video from a content decryption module. The decrypted video may be associated with a content element and a digital rights management technology. The method may include forming, using the computing device, a HyperText Markup Language (HTML) element including the decrypted video. The method may include outputting, using an operating system of the computing device, the decrypted video of the HTML element to a display screen associated with the computing device. The method may include determining, using the computing device, whether the outputted video is being played on the display screen. The method may also include transmitting, using the operating system of the computing device, the determination to the content decryption module.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an example environment, according to one or more embodiments.

FIG. 2 depicts a flowchart of an example method, according to one or more embodiments.

FIG. 3 depicts a flowchart of an example method, according to one or more embodiments.

FIG. 4 depicts a flowchart of an example method, according to one or more embodiments.

FIG. 5 depicts an example computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, the term “screenshare” may refer to a real time or near real time electronic transmission of data displayed on a display screen of a user's computing device to one or more other computing devices. The term “screensharing” and the phrase “being screenshared” may refer to performing a screenshare. In some aspects, screensharing may be performed using a screensharing application (e.g., a video or web conferencing application such as Zoom®, Microsoft's Teams®, or the like, or a remote desktop application such as Microsoft Remote Desktop, Chrome Remote

Desktop, or the like). As used herein, the term “screenshot” may represent an image of data displayed on a display screen of a computing device, where the image may be captured or recorded. The term “screenshotting” and the phrase “being screenshotted” may refer to capturing or recording a screenshot. In some aspects, screenshotting may be performed using a screenshotting application (e.g., the Snipping Tool in Microsoft's Windows 11 or an application accessed using a Print Screen key of a keyboard or keypad).

As used herein, the phrase “resources associated with a portal” may refer to, for example, funds, accounts (e.g., financial accounts), credit cards, debit cards, data, or data profiles (e.g., collections of data), that are associated with or referenced in a portal. As used herein, the term “sensitive data” may refer to data that is intended for, or restricted to the use of, one or more users or entities. Sensitive data may represent data that is personal, private, confidential, privileged, secret, classified, or in need of protection. Examples of sensitive data may include financial data such as account numbers, credit card account numbers, checking account numbers, virtual card numbers, savings account numbers, account balances, credit card account balances, checking account balances, savings account balances, financial statements, bills, or invoices; personally identifiable information such as a name, address, phone number, social security number, or driver's license number; medical information such as a patient's medical history, a doctor's summary or diagnosis, or medical test results; academic information such as a student's grades or transcript; business information such as trade secrets, proprietary information, or business strategy information; governmental information such as classified or secret information related to national security or defense); or data that is copyrighted, etc. As used herein, the term “error callback function” may refer to a means of notifying a caller (e.g., a webpage or an application server) that an error has occurred (e.g., that a DRM-protected video has been blocked from playing).

In the following description, embodiments will be described with reference to the accompanying drawings. As will be discussed in more detail below, various embodiments, methods, and systems for securing content of a portal (e.g., a webpage, a website, an application, etc.) and resources associated with the portal, are described.

In an exemplary use case, a customer of a bank may use a user device (e.g., a laptop) to obtain financial information. More specifically, the customer may use a browser presented on a display screen of the user device to load a webpage that is associated with the bank, and on which the customer anticipates viewing the customer's checking account balance. In some embodiments, the checking account balance may represent sensitive data. Sensitive data may refer to data that is intended for, or restricted to the use of, one or more users or entities (e.g., the customer and the bank).

As the webpage is loaded, an application server associated with the bank may generate a video that is protected using a DRM technology (or that is DRM-protected) and associated with the checking account balance. The video may also be encrypted. In some embodiments, the encrypted video may include a single image frame (e.g., a video frame such as a single-frame video) depicting (or representing) the checking account balance, and the encrypted video (once decrypted) may be configured to be presented on the display screen of the user device such that the decrypted video is presented on top of a portion of the webpage that displays a background color (or colors) of the webpage, for example. In some other embodiments, the encrypted video may include a single image frame (or video frame) that is transparent (e.g., clear and not depicting the checking account balance) and the encrypted video (once decrypted) may be configured to be presented on the display screen, on top of the checking account balance of the webpage, so that when the decrypted video is played, the user can view the checking account balance under the transparent image frame. In some aspects, the encrypted video (including a single image frame that is either transparent or depicts the checking account balance), once decrypted, may be configured to (i) play in a loop on the display screen of the user device when the display screen is not being screenshared or screenshotted, and (ii) not play in a loop (or be blocked from playing) on the display screen of the user device when the display screen is being screenshared or screenshotted.

Once the encrypted video is generated, the application server may transmit the encrypted video to a content decryption module (also referred to herein as a “CDM” or “DRM platform”). The CDM may decrypt the encrypted video, and transmit the decrypted video to the user device. In some embodiments, the browser of the user device may form an HTML element including the decrypted video, where the HTML element is a component of an HTML page that represents the webpage associated with the bank. In some embodiments, where the decrypted video includes a single image frame depicting the checking account balance, an operating system of the user device may output the decrypted video of the HTML element to the display screen, while the browser outputs the remainder of the webpage (or a portion of the webpage not including the checking account balance) to the display screen, where the decrypted video may be presented on top of a background color (or colors) of the webpage, for example. In some other embodiments, where the decrypted video includes a single image frame that is transparent, the operating system of the user device may output, to the display screen, the decrypted video and the checking account balance (for display under the decrypted video), while the browser outputs the remainder of the webpage (or a portion of the webpage not including the checking account balance) to the display screen.

In some embodiments, where the user does not screenshare or screenshot the display screen on which the webpage is presented, the decrypted video (including the single image frame that either depicts the checking account balance or is transparent) may be played in a loop so that the user can view the checking account balance on the display screen. In some aspects, the checking account balance may appear to the user as a still frame on the display screen during the playing. The user device (e.g., the operating system of the user device) may determine that the decrypted video is being played on the display screen, and transmit the determination to the CDM, which may track (e.g., log or store) the determination.

If the user begins to screenshare, or take a screenshot of, the display screen with a social engineer (or potential social engineer), the DRM technology and the operating system of the user device may cause the decrypted video (including the single image frame that either depicts the checking account balance or is transparent) to not play in a loop (or be blocked from playing) on the display screen. Consequently, the decrypted video may appear as a region or window that does not display the checking account balance (e.g., a region or window showing the background color (or colors) of the webpage, solid black, or another color or design) so that neither the social engineer nor the user can view the checking account balance. In some aspects, the user device (e.g., the operating system of the user device) may determine that the decrypted video is not being played, and transmit the determination to the CDM. The CDM may track the determination and transmit the determination to the application server, optionally via the browser of the user device.

In some aspects, because the determination that the decrypted video is not being played may represent that the user attempted to share the user's checking account balance with the social engineer (or a potential social engineer), and because the social engineer (or potential social engineer) may have learned the user's checking account balance during the screenshare (e.g., orally from the user via a screensharing application) despite the decrypted video not playing, the application server may determine one or more security measures to perform in order to prevent any transactions involving the social engineer (or potential social engineer) and the user's checking account. For example, the application server may cause the user's checking account to be more closely tracked or monitored, or be locked or frozen. In addition or in the alternative, the application server may cause a notification to be output on the webpage, where the notification may inform the user of the risks associated with the screensharing.

Accordingly, aspects of the present disclosure allow the bank (or another entity associated with the application server and the webpage) to be notified when the webpage may be screenshared or screenshotted with a social engineer or potential social engineer. Consequently, the bank (or other entity) may take steps to prevent, mitigate, or halt any fraudulent activities (e.g., fraudulent transactions) associated with the webpage, and in turn protect any resources associated with the webpage (e.g., funds, accounts, data, data profiles, etc.). Further, unlike existing technologies for securing content displayed on a portal, aspects of the present disclosure permit an operating system of a user device to communicate to a CDM whether a video that is DRM-protected is being played on a display screen of the user device. Embodiments described herein also permit a CDM to track such communications, and to forward the communications to an application server, optionally via a browser of the user device.

While the example above involves a webpage and checking account balance, it should be understood that techniques according to this disclosure may be adapted to any suitable type of program (e.g., a website, portal, application, browser extension, plugin, or the like) and data (e.g., sensitive data, non-sensitive data, text data, image data, audio data, or the like), respectively. It should also be understood that the example above is illustrative only. The techniques and technologies of this disclosure may be adapted to any suitable activity.

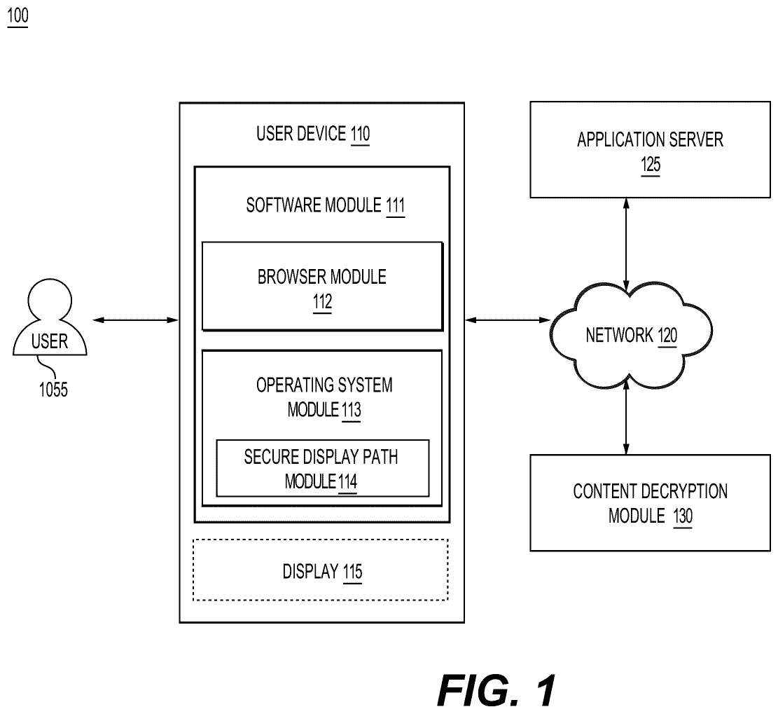

FIG. 1 depicts an example environment 100 that may be utilized with techniques presented herein. In some aspects, the environment 100 may be an embodiment of (i) the environment 100 described in U.S. Provisional Application 63/587,891, filed Oct. 4, 2023, (ii) the environment 100 described in U.S. Provisional Application 63/665,485, filed Jun. 28, 2024, or (iii) the environment 100 described in U.S. Provisional Application 63/683,063, filed Aug. 14, 2024, where each of these U.S. provisional applications is incorporated by reference herein in its entirety. As shown in FIG. 1, the environment 100 may include a user device 110, a network 120 (e.g., an electronic network), an application server 125, and a CDM 130. In some aspects, the user device 110, the application server 125, and the CDM 130 may communicate with one another in any arrangement across the network 120. The user device 110 may be associated with a user 105. In some embodiments, the user 105 may be a customer or employee of, or contractor for, a company, business, or organization (e.g., a bank, a hospital, a university, etc.), or the like. Further, in some embodiments, the company, business, or organization may be associated with (e.g., own, rent, or control) the user device 110. In some other embodiments, the user 105 may own, rent, or control the user device 110. Further, in some embodiments, the user 105 may be an authorized user of the user device 110 and a portal accessed using the user device 110.

The user device 110 may be configured to enable the user 105 to access or interact with the network 120, the application server 125, and the CDM 130, in the environment 100. For example, the user device 110 may be a computer system such as a desktop computer, a laptop, a workstation, a mobile device, a tablet, etc. In some embodiments, the user device 110 may include one or more software modules, which may represent electronic application(s) such as a program, a platform, a plugin, or a browser extension, installed on a memory of the user device 110. For example, as shown in FIG. 1, the user device 110 may include a software module 111 that may represent (or include), for example, a browser module 112 and an operating system module 113. The user device 110 may optionally include a display 115 (e.g., a display screen configured to display or present data received from the browser module 112 or the operating system module 113).

The browser module 112 may include one or more browsers (e.g., web browsers or applications for accessing and viewing content on the internet, the World Wide Web, a cloud platform, etc.). In some embodiments, the browser module 112 may be configured to communicate with the operating system module 113, the display 115, the network 120, and the application server 125 and the CDM 130, via the network 120. For example, in response to the user 105 inputting a web address (or uniform resource locator) to the browser module 112 (e.g., using the display 115 or a keyboard or other input/output device associated with the user device 110), the browser module 112 may be configured to transmit a request for a webpage (or website, portal, application, etc.) associated with the web address, to the application server 125 via the network 120. The browser module 112 may also be configured to receive the webpage from the application server 125 via the network 120. In some aspects, the browser module 112 may be configured to load, render, or output the webpage (or a portion of the webpage) to the display 115 directly, or indirectly via the operating system module 113.

In some aspects, the webpage received (or outputted) by the browser module 112 may include one or more content elements. In some aspects, a content element may represent data such as text data (e.g., letters, numbers, symbols, metadata, or alt text), image data (e.g., an image, a graphic, a sequence of image frames, or a video), or audio data (e.g., a sequence of audio frames). Further, a content element may represent data included in, or referred by, an HTML element of an HTML page corresponding to (or representing) the webpage. An HTML element may represent a component of an HTML page, and may include, for example, a start tag, an end tag, and as noted above, a content element or a reference to a content element (e.g., a link, hyperlink, address, or path to a content element). Further, in some embodiments, an HTML element may include one or more HTML elements (e.g., nested HTML elements).

In some embodiments, one or more content elements of the webpage may include sensitive data or non-sensitive data. As explained above, sensitive data may refer to data that is intended for, or restricted to the use of, one or more users or entities (e.g., the user 105 and an organization associated with the application server 125). Moreover, sensitive data may represent data that is personal, private, confidential, privileged, secret, classified, or in need of protection. Sensitive data may further represent, for example, financial data such as account numbers, credit card account numbers, checking account numbers, savings account numbers, virtual card numbers, account balances, credit card account balances, checking account balances, savings account balances, financial statements, bills, or invoices; personally identifiable information such as a name, address, phone number, social security number, or driver's license number; medical information such as a patient's medical history, a doctor's summary or diagnosis, or medical test results; academic information such as a student's grades or transcript; business information such as trade secrets, proprietary information, or business strategy information; governmental information such as classified or secret information related to national security or defense); or data that is copyrighted, etc.

In some embodiments, the browser module 112 may be configured to determine whether one or more content elements of the webpage include sensitive data. The browser module 112 may also be configured to transmit this determination to the application server 125 via the network 120. In some embodiments, the browser module 112 may be configured to receive one or more content elements of the webpage from the CDM 130. For example, the browser module 112 may be configured to receive a DRM-protected, decrypted video from the CDM 130. The browser module 112 may also be configured to communicate with a secure display path module 114 of the operating system module 113. For example, the browser module 112 may be configured to receive a determination from the secure display path module 114 that a video that is DRM-protected and decrypted is or is not playing on the display 115, and the browser module 112 may be configured to transmit this determination to the CDM 130 or the application server 125, via the network 120. Further, in some embodiments, the browser module 112 may be configured to receive a determination from the CDM 130 that a video that is DRM-protected and decrypted is or is not playing on the display 115, and the browser module 112 may be configured to transmit this determination to the application server 125, via the network 120.

In some embodiments, the operating system module 113 may include one or more operating systems. In some aspects, an operating system may represent software configured to (i) manage hardware and software resources of the user device 110 or (ii) provide services for applications associated with the user device 110. As explained above, the operating system module 113 may include the secure display path module 114 (also referred to herein as the “secure display path 114”). In some aspects, the secure display path 114 may represent (or include) one or more DRM technologies (or DRM functions) used to protect or secure content element(s) that the secure display path 114 receives from the browser module 112 or the CDM 130. The secure display path 114 may be native (or specific) to a respective operating system of the operating system module 113. In some embodiments, the secure display path 114 may represent Microsoft's Protected Media Path, for example.

In some aspects, the secure display path module 114 may be configured to load, render, or output to the display 115, one or more content elements of the webpage for presentation while the browser module 112 concurrently loads, renders, or outputs to the display 115, the remainder of the webpage. For example, where a content element of the webpage represents a DRM-protected video that is decrypted and includes an image frame depicting sensitive data (e.g., a checking account balance), the secure display path module 114 may load, render, or output the DRM-protected video to the display 115 (and the browser module 112 may concurrently load, render, or output to the display 115, the remainder of the webpage, for example). In some aspects, the DRM-protected video may be presented over background color(s) of the remainder of the webpage, on the display 115. As another example, where a first content element of the webpage represents a DRM-protected video that is decrypted and includes an image frame that is transparent, and where a second content element represents sensitive data (e.g., a checking account balance), the secure display path module 114 may load, render, or output the first and second content elements to the display 115 (and the browser module 112 may concurrently load, render, or output to the display 115, the remainder of the webpage, for example). In some aspects, the first content element (the DRM-protected video) may be presented on top of (or be overlaid on) the second content element (the sensitive data) on the display 115. Further, when the first content element (the DRM-protected video) is played on the display 115 (e.g., in a loop), the user 105 may view the second content element (the sensitive data) presented under the first content element (e.g., the transparent image frame of the DRM-protected video).

In some aspects, the secure display path 114 may be configured to protect (or secure) one or more content elements (e.g., a DRM-protected, decrypted video of the webpage or sensitive data of the webpage) by blocking or preventing the one or more content elements from being loaded, rendered, or output to or played on the display 115, when the display 115 is being screenshared (e.g., using a screensharing application or remote desktop application) or screenshotted (e.g., using a screenshotting application). The secure display path 114 may further be configured to determine when the one or more content elements are blocked from being loaded, rendered, or output to or played on the display 115 (or when the display 115 is being screenshared or screenshotted). Unlike conventional DRM systems (e.g., Google's Widevine), the secure display path 114 may be configured to transmit such a determination to the CDM 130, which may help the CDM 130 track and identify potential instances of social engineering (e.g., instances in which the display 115 is screenshared or screenshotted with a social engineer or potential social engineer).

The application server 125 may be a computing system such as a server, a workstation, a desktop computer, a laptop, a mobile device, a tablet, etc. In some examples, the application server 125 may be associated with (or include) a cloud computing platform with scalable resources for computation or data storage. The application server 125 may run one or more applications locally or using the cloud computing platform, to perform various computer-implemented methods described in this disclosure. In some embodiments, the application server 125 may be associated with (e.g., owned, rented, or controlled by) a company, a business, or an organization, such as a bank, a hospital, a university, or a merchant, etc.

In some aspects, the application server 125 may be configured to communicate with the user device 110 and the CDM 130, via the network 120. For example, the application server 125 may be configured to transmit an HTML page (or file) corresponding to a webpage to the browser module 112 via the network 120. In some embodiments, the application server 125 may be configured to receive a notification (or determination) from the browser module 112 that one or more content elements of the HTML page include sensitive data. Further, in some embodiments, the application server 125 may be configured to determine whether one or more content elements of the HTML page (or webpage) include sensitive data. In response to determining (or receiving a determination) that a content element (e.g., text data) includes sensitive data, the application server 125 may generate and encrypt a DRM-protected video that includes either (i) a transparent image frame associated with the sensitive data (e.g., a transparent image frame configured to be presented over the sensitive data on the display 115) or (ii) an image frame that depicts or represents the sensitive data. The application server 125 may also be configured to transmit the encrypted, DRM-protected video, along with an error callback function that is associated with the encrypted, DRM-protected video, to the CDM 130.

Unlike conventional DRM systems, the application server 125 may be configured to receive a notification from the CDM 130 (optionally via the browser module 112) regarding whether a DRM-protected video is being played on the display 115, which may help the application server 125 (and the entity associated with the application server 125) track, identify, or respond to potential instances of social engineering (e.g., instances in which the display 115 is screenshared or screenshotted with a social engineer or potential social engineer). For example, in response to receiving a notification from the CDM 130 (optionally via the browser module 112) that a DRM-protected video of a webpage is not playing (or has been blocked from being played) on the display 115, the application server 125 may determine one or more security measures to perform in order to prevent, halt, or mitigate any fraudulent activities associated with the webpage. For example, the application server 125 may determine to perform (or initiate) one or more of the following security measures: (i) cause resources associated with the webpage (a portal) to be more closely tracked or monitored, or be locked or frozen, for a fixed period of time or indefinitely; (ii) log data (or increase logging of data) concerning the user 105's or another person's or entity's usage of the webpage; (iii) impose limitations or restrictions on any features or resources (e.g., accounts, data, or data profiles, etc.) associated with, or referenced, in the webpage or DRM-protected video (e.g., disable sensitive features associated with the webpage); (iv) automatically issue a new credit card or data (e.g., security pins or passwords) to the user 105; (v) freeze any wire transfers or transactions involving account(s) associated with, or referenced in, the webpage or DRM-protected video; (vi) render obsolete any virtual card numbers associated with, or referenced in, the webpage or DRM-protected video; (vii) modify (e.g., increase) any fraud alerts related to any accounts associated with, or referenced in, the webpage or DRM-protected video, thereby causing any credit cards, debit cards, or virtual cards associated with the accounts to be declined more often; or (viii) transmit a notification to the user device 110 for display on the display 115, where the notification may relate to screensharing or screenshotting the webpage presented on the display 115. In some embodiments, the notification may warn the user 105 of risks associated with screensharing or screenshotting the webpage displayed on the display 115 with a social engineer or potential social engineer. Further, the notification may inform the user 105 that an entity associated with the webpage and the application server 125 would never (or not) ask the user 105 to screenshare or screenshot the webpage displayed on the display 115. In some embodiments, the notification may represent a fraud alert and be transmitted from the application server 125 to other devices, or other portals, associated with the user 105.

In some aspects, the CDM 130 (or DRM platform 130) may be configured to communicate with the user device 110 and the application server 125, via the network 120. For example, the CDM 130 may be configured to receive an encrypted, DRM-protected video and an associated error callback function, from the application server 125. The CDM 130 may also be configured to decrypt the encrypted, DRM-protected video, and transmit the decrypted video to the user device 110 (e.g., to the browser module 112 or the operating system module 113). Unlike existing DRM systems, the CDM 130 may be configured to receive, from the secure display path 114, a determination that the decrypted, DRM-protected video is not playing (or has been blocked from playing) on the display 115 (or that the display 115 has been screenshared or screenshotted). The CDM 130 may further be configured to log (or store) the determination, so that the CDM 130 can track (or identify) potential instances of social engineering (e.g., instances in which the display 115 is screenshared or screenshotted with a social engineer or potential social engineer). In some aspects, unlike conventional DRM systems, the CDM 130 may be configured to transmit the determination to the application server 125 (or call the error callback function by calling the webpage, the HTML page corresponding to the webpage, or the application server 125), optionally via the browser module 112, so that the application server 125 can track and respond to the determination in order to prevent or mitigate any fraudulent activities associated with the screensharing or screenshotting.

In various embodiments, the network 120 may be a wide area network (“WAN”), a local area network (“LAN”), personal area network (“PAN”), or the like. In some embodiments, network 120 may include the Internet, and support the transmission of information and data between various systems online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page,” “website,” or “webpage” generally encompasses a location, data store, or the like that is, for example, hosted or operated by a computer system so as to be accessible online, and that may include data configured to cause a program such as a browser to perform operations such as send, receive, or process data, generate a visual display or an interactive interface, or the like

Although depicted as separate components in FIG. 1, it should be understood that a component or portion of a component in the environment 100 may, in some embodiments, be integrated with or incorporated into one or more other components. For example, in some embodiments, at least a portion of the application server 125 or the CDM 130 may be integrated into the user device 110. In some embodiments, operations or aspects of one or more of the components discussed above may be distributed amongst one or more other components. Any suitable arrangement or integration of the various systems and devices of the environment 100 may be used. Further, in some embodiments, the environment 100 may include multiple user devices 110, multiple application servers 125, or multiple CDMs 130.

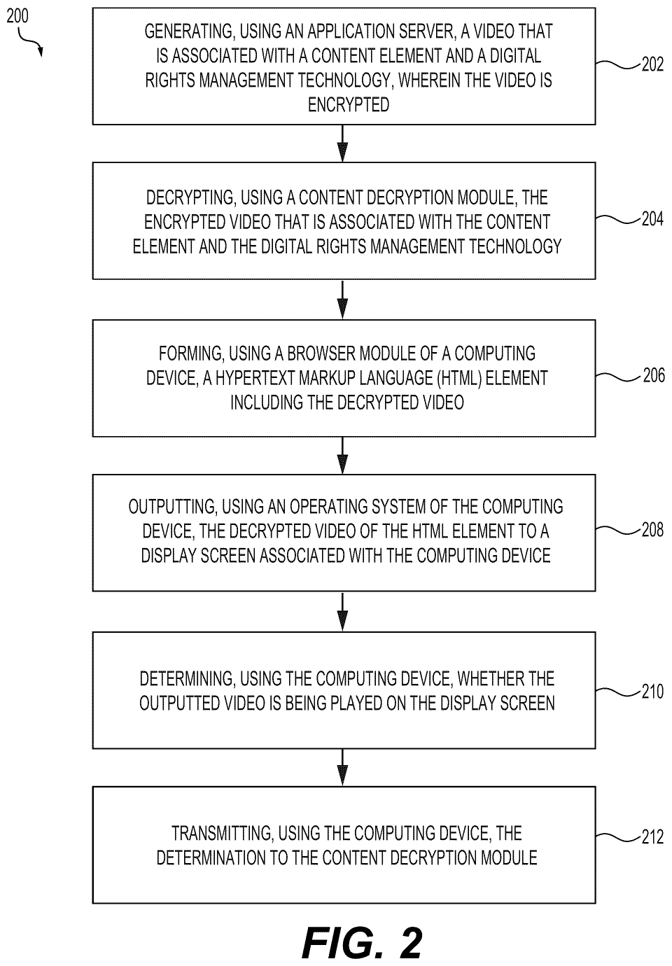

FIG. 2 is a flowchart illustrating a method 200 for securing content of a portal and resources associated with the portal, according to one or more embodiments of the present disclosure. As shown in FIG. 2, the method 200 may include generating, using an application server (e.g., the application server 125), a video that is associated with a content element and a digital rights management technology, wherein the video is encrypted (202). In some embodiments, the content element may represent sensitive data. Further, in some embodiments, the encrypted video may include a single image frame (or video frame) that depicts (or represents) the content element. In some other embodiments, the encrypted video may include a single image frame (or video frame) that is transparent (or clear) and configured to be presented on top of the content element on a display screen (e.g., the display 115). In some aspects, the encrypted video may be protected by the digital rights management technology.

The method 200 may include decrypting, using a content decryption module (e.g., the CDM 130), the encrypted video that is associated with the content element and the digital rights management technology (204). The method 200 may include forming, using a browser module (e.g., the browser module 112) of a computing device (e.g., the user device 110), a HyperText Markup Language (HTML) element including the decrypted video (206).

In some embodiments, the method 200 may include outputting, using an operating system (e.g., the operating system module 113 or the secure display path module 114) of the computing device, the decrypted video of the HTML element to a display screen (e.g., the display 115) associated with the computing device (208). In some embodiments, the operating system of the computing device may be used to (i) present the decrypted video on the display screen, where the decrypted video includes a transparent image frame, and (ii) present the content element on the display screen, where the decrypted video being presented is overlaid on the content element presented on the display screen. In some other embodiments, the operating system of the computing device may be used to present the decrypted video on the display screen, where the decrypted video includes an image frame depicting the content element.

As shown in FIG. 2, the method 200 may include determining, using the computing device (e.g., the operating system module 113 or the secure display path module 114), whether the outputted video is being played (e.g., in a loop) on the display screen (210). In some embodiments, the determination may include a determination that the outputted video is not playing (or being blocked from playing) on the display screen, which may represent that the display screen is being screenshared or screenshotted. In some other embodiments, the determination may include a determination that the outputted video is playing (or is not being blocked from playing) on the display screen, which may represent that the display screen is not being screenshared or screenshotted

In some embodiments, the method 200 may include transmitting, using the computing device (e.g., the operating system module 113 or the secure display path module 114), the determination to the content decryption module (212). The content decryption module may store the determination and transmit the determination to the application server (optionally by way of, or through, the browser module of the computing device). In some aspects, the content decryption module may transmit the determination to the application server (optionally via the browser module of the computing device) using an error callback function received from the application server.

In some embodiments, the application server may be used to determine one or more security measures to perform based on the determination that the outputted video is not playing on the display screen. Further, in some embodiments, the computing device may output a notification to the display screen, where the notification may be associated with the determination that the outputted video is not playing on the display screen. In some embodiments, the application server may generate the notification, or initiate or trigger the notification for display on the display screen.

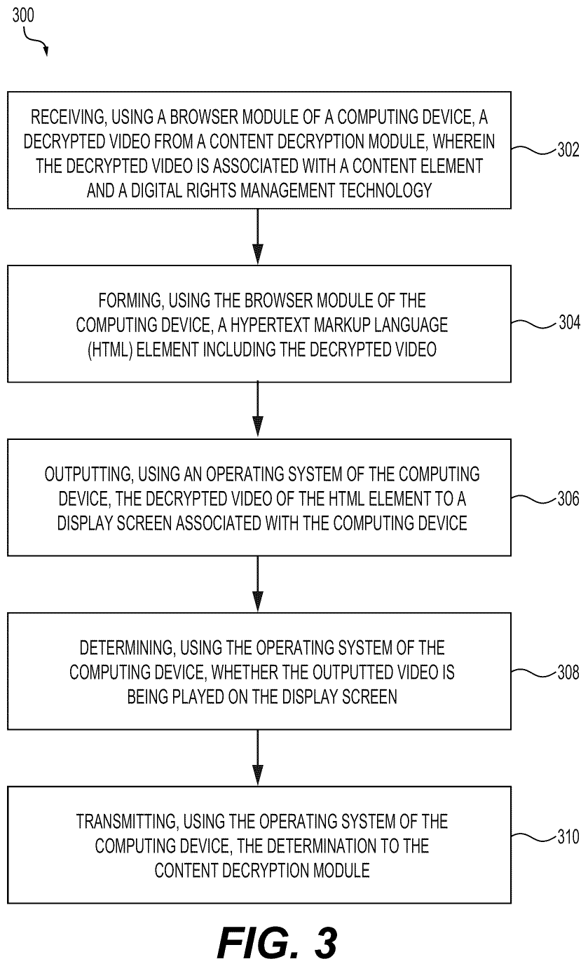

FIG. 3 is a flowchart illustrating a method 300 for securing content of a portal and resources associated with the portal, according to one or more embodiments of the present disclosure. In some embodiments, the method 300 may be performed by the user device 110 of FIG. 1. In some aspects, the method 300 may be an embodiment of the method 200 of FIG. 2.

As shown in FIG. 3, in some embodiments, the method 300 may include receiving, using a browser module (e.g., the browser module 112) of a computing device (e.g., the user device 110), a decrypted video from a content decryption module (e.g., the CDM 130), where the decrypted video is associated with a content element and a digital rights management technology (302). In some other embodiments, an operating system (e.g., the operating system module 113 or the secure display path module 114) of a computing device may be used to receive a decrypted video from a content decryption module. In some aspects, the content element may represent sensitive data. Further, in some embodiments, the decrypted video may include a single image frame (or video frame) that depicts (or represents) the content element. In some other embodiments, the decrypted video may include a single image frame (or video frame) that is transparent (or clear) and configured to be presented on top of the content element on a display screen (e.g., the display 115). In some aspects, the decrypted video may be protected by the digital rights management technology.

The method 300 may further include forming, using a browser module (e.g., the browser module 112) of the computing device, a HyperText Markup Language (HTML) element including the decrypted video (304). The method 300 may include outputting, using the operating system of the computing device, the decrypted video of the HTML element to a display screen (e.g., the display 115) associated with the computing device (306). The method 300 may include determining, using the operating system (e.g., the operating system module 113 or the secure display path module 114) of the computing device, whether the outputted video is being played (e.g., in a loop) on the display screen (308). The method 300 may also include transmitting, using the operating system (e.g., the operating system module 113 or the secure display path module 114) of the computing device, the determination to the content decryption module (310).

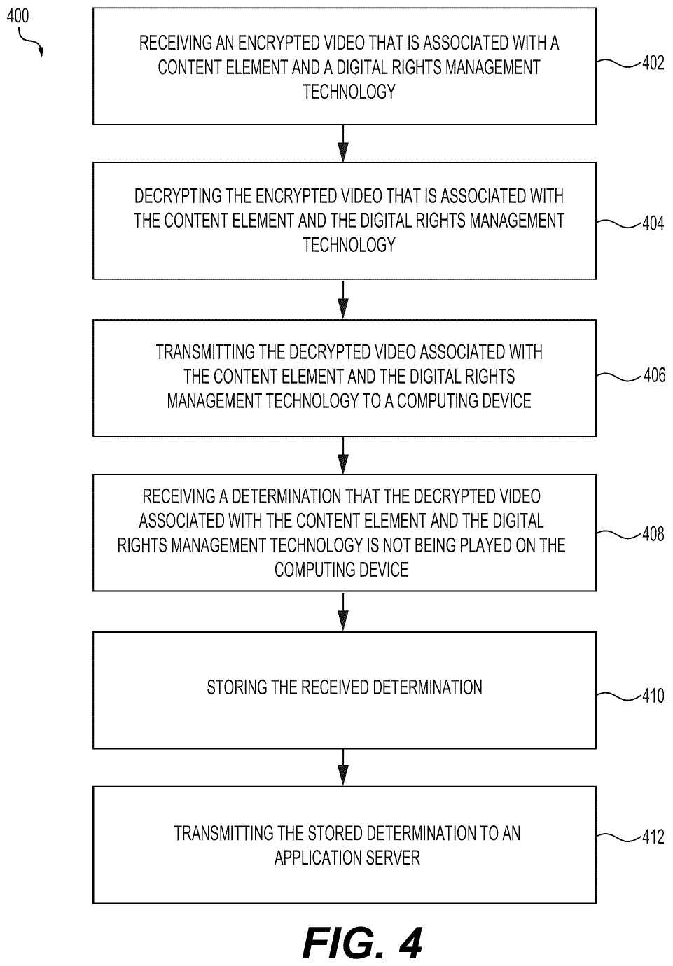

FIG. 4 is a flowchart illustrating a method 400 for securing content of a portal and resources associated with the portal, according to one or more embodiments of the present disclosure. In some embodiments, the method 400 may be performed by the CDM 130 of FIG. 1. In some aspects, the method 400 may be an embodiment of the method 200 or 300 of FIGS. 2 and 3, respectively.

As shown in FIG. 4, the method 400 may include receiving an encrypted video that is associated with a content element and a digital rights management technology (402). In some embodiments, the content element may represent sensitive data. Further, in some embodiments, the encrypted video may include a single image frame (or video frame) that depicts (or represents) the content element. In some other embodiments, the encrypted video may include a single image frame (or video frame) that is transparent (or clear) and configured to be presented on top of the content element on a display screen (e.g., the display 115). In some aspects, the encrypted video may be protected by the digital rights management technology.

In some embodiments, the method 400 may include decrypting the encrypted video that is associated with the content element and the digital rights management technology (404). The method 400 may include transmitting the decrypted video associated with the content element and the digital rights management technology to a computing device (406). The method 400 may further include receiving a determination that the decrypted video associated with the content element and the digital rights management technologies is not being played on the computing device (408). The method 400 the received determination (410), and transmitting the stored determination to an application server (optionally via the computing device) (412).

In general, any process or operation discussed in this disclosure that is understood to be computer-implementable, such as the processes (or methods) illustrated in FIGS. 2, 3, and 4, may be performed by one or more processors of a computer system, such as any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

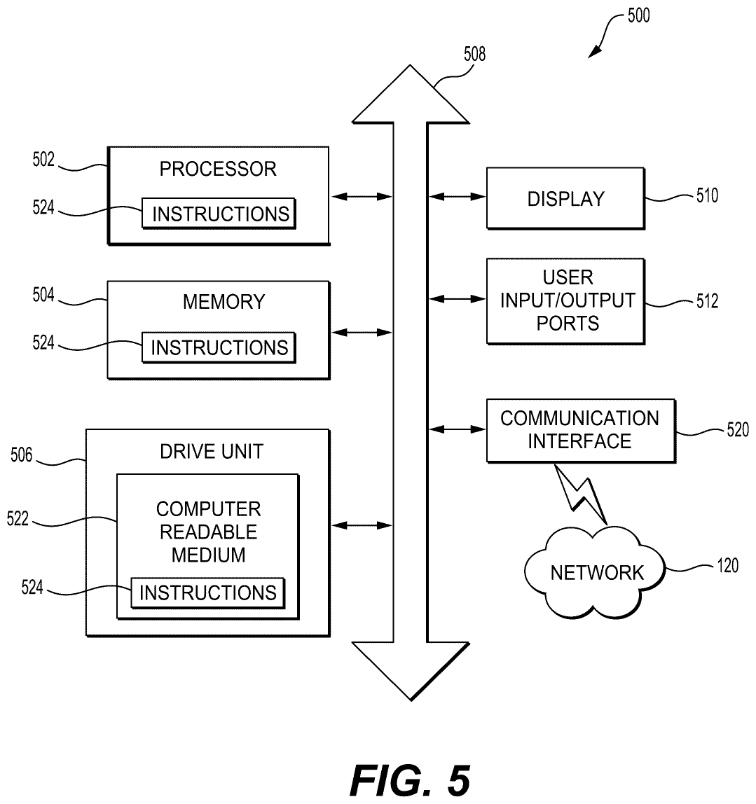

FIG. 5 is a simplified functional block diagram of a computer 500 that may be configured as a device for executing the methods of FIG. 2, 3, or 4, according to exemplary embodiments of the present disclosure. For example, in some embodiments, the computer 500 may be configured as the user device 110, according to exemplary embodiments of this disclosure. In some other embodiments, the computer 500 may be configured as the application server 125, according to exemplary embodiments of this disclosure. In some other embodiments, the computer 500 may be configured as the CDM 130, according to exemplary embodiments of this disclosure. In various embodiments, any of the devices or systems herein may be a computer 500 including, for example, a data communication interface 520 for packet data communication. The computer 500 also may include a central processing unit (“CPU”) 502, in the form of one or more processors, for executing program instructions. The computer 500 may include an internal communication bus 508, and a storage (or drive) unit 506 (such as ROM, HDD, SDD, etc.) that may store data on a computer readable medium 522, although the computer 500 may receive programming and data via network communications. The computer 500 may also have a memory 504 (such as RAM) storing instructions 524 for executing techniques presented herein, although the instructions 524 may be stored temporarily or permanently within other modules of computer 500 (e.g., processor 502 or computer readable medium 522). The computer 500 also may include input and output ports 512 or a display (or display screen) 510 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method comprising:
receiving, using a browser module of a computing device, a decrypted video from a content decryption module, wherein the decrypted video is associated with a content element and a digital rights management technology;
forming, using the browser module of the computing device, a HyperText Markup Language (HTML) element including the decrypted video;
outputting, using an operating system of the computing device, the decrypted video of the HTML element to a display screen associated with the computing device;
determining, using the operating system of the computing device, whether the outputted video is being played on the display screen; and
transmitting, using the operating system of the computing device, the determination to the content decryption module.

2. The method of claim 1, wherein transmitting, using the operating system of the computing device, the determination to the content decryption module comprises:
transmitting, using a secure display path of the operating system of the computing device, the determination to the content decryption module.

3. The method of claim 1, wherein determining, using the operating system of the computing device, whether the outputted video is being played on the display screen comprises:
determining, using a secure display path of the operating system of computing device, whether the outputted video is being played on the display screen.

4. The method of claim 1, wherein the content element includes sensitive data.

5. The method of claim 1, wherein the determination includes a determination that the outputted video is playing on the display screen.

6. The method of claim 1, wherein the determination includes a determination that the outputted video is not playing on the display screen, and wherein the method further comprises:
outputting, using the computing device, a notification to the display screen, wherein the notification is associated with the determination that the outputted video is not playing on the display screen.

7. The method of claim 1, wherein the determination includes a determination that the outputted video is not playing on the display screen.

8. The method of claim 7, wherein the determination that the outputted video is not playing on the display screen represents that the display screen is being screenshared or screenshotted.

9. The method of claim 1, wherein outputting, using the operating system of the computing device, the decrypted video of the HTML element to the display screen associated with the computing device comprises:
presenting, using the operating system of the computing device, the decrypted video on the display screen, wherein the decrypted video includes a transparent image frame, and wherein the method further includes:
presenting, using the operating system of the computing device, the content element on the display screen, wherein the decrypted video being presented is overlaid on the content element presented on the display screen.

10. The method of claim 1, wherein outputting, using the operating system of the computing device, the decrypted video of the HTML element to the display screen associated with the computing device comprises:
presenting, using the operating system of the computing device, the decrypted video on the display screen, wherein the decrypted video includes an image frame depicting the content element.

11. A system comprising:
at least one processor; and
at least one memory having programming instructions stored thereon, which, when executed by the at least one processor, cause the system to perform operations comprising:
receiving, using a computing device, a decrypted video from a content decryption module, wherein the decrypted video is associated with a content element and a digital rights management technology;
forming, using a browser module of the computing device, a HyperText Markup Language (HTML) element including the decrypted video;
outputting, using an operating system of the computing device, the decrypted video of the HTML element to a display screen associated with the computing device;
determining, using the computing device, whether the outputted video is being played on the display screen; and
transmitting, using the operating system of the computing device, the determination to the content decryption module.

12. The system of claim 11, wherein transmitting, using the operating system of the computing device, the determination to the content decryption module comprises:
transmitting, using a secure display path of the operating system of the computing device, the determination to the content decryption module.

13. The system of claim 11, wherein determining, using the computing device, whether the outputted video is being played on the display screen comprises:
determining, using a secure display path of the operating system of the computing device, whether the outputted video is being played on the display screen.

14. The system of claim 11, wherein the content element includes sensitive data.

15. The system of claim 11, wherein the determination includes a determination that the outputted video is playing on the display screen.

16. The system of claim 11, wherein the determination includes a determination that the outputted video is not playing on the display screen, and wherein the operations further comprise:
outputting, using the computing device, a notification to the display screen, wherein the notification is associated with the determination that the outputted video is not playing on the display screen.

17. The system of claim 11, wherein the determination includes a determination that the outputted video is not playing on the display screen, wherein the determination that the outputted video is not playing on the display screen represents that the display screen is being screenshared or screenshotted.

18. The system of claim 11, wherein outputting, using the operating system of the computing device, the decrypted video of the HTML element to the display screen associated with the computing device comprises:
presenting, using the operating system of the computing device, the decrypted video on the display screen, wherein the decrypted video includes a transparent image frame, and wherein the operations further include:
presenting, using the operating system of the computing device, the content element on the display screen, wherein the decrypted video being presented is overlaid on the content element presented on the display screen.

19. The system of claim 11, wherein outputting, using the operating system of the computing device, the decrypted video of the HTML element to the display screen associated with the computing device comprises:
presenting, using the operating system of the computing device, the decrypted video on the display screen, wherein the decrypted video includes an image frame depicting the content element.

20. A method comprising:
receiving, using a computing device, a decrypted video from a content decryption module, wherein the decrypted video is associated with a content element and a digital rights management technology;
forming, using the computing device, a HyperText Markup Language (HTML) element including the decrypted video;
outputting, using an operating system of the computing device, the decrypted video of the HTML element to a display screen associated with the computing device;
determining, using the computing device, whether the outputted video is being played on the display screen; and
transmitting, using the operating system of the computing device, the determination to the content decryption module.
